(19) United States
(12) Patent Application Publication
(10) Pub. No.: US 2006/0294224 A1
(43) Pub. Date: Dec. 28, 2006

(54) Electrical power management system

(75) Inventors: Donald B. Wilson, Dowelltown, TN (US); Roger D. Love, Murfreesboro, TN (US); Alban Pierre-Henri Cambournac, Nashville, TN (US); Craig A. Spangler, Smyrna, TN (US)

Correspondence Address: SQUARE D COMPANY;LEGAL DEPARTMENT - I.P. GROUP, 1415 SOUTH ROSELLE ROAD, PALATINE, IL, 60067, US

(73) Assignee: Square D Company

(21) Appl. No.: 11/167,654

(22) Filed: Jun. 27, 2005

(51) Int. Cl. G06F 15/173

(52) U.S. Cl. 709/224

(57) ABSTRACT

A system for monitoring an electrical power distribution system monitors a selected device or quantity in the power distribution system and produces an output signal representing a sensed condition; receives and stores data relating to the sensed condition from the power distribution system; stores a display of at least a portion of the stored data relating to the sensed condition; produces a message in response to a change in the output signal representing a change in the sensed condition and transmits the message to remote recipients, the message including a hyperlink to the display so that a recipient of the message can use the hyperlink to automatically access the display to view data relating to the reported change in the sensed condition. In one specific embodiment, the message is an email message that is automatically transmitted to preselected remote recipients in response to the change in the sensed condition.

### FIELD OF THE INVENTION

This invention is directed generally to electrical power management systems that include monitoring devices such as circuit monitors, lighting control systems, meters, circuit breaker controllers, power monitors and the like. The invention particularly relates to systems for communicating with such monitoring devices.

### BACKGROUND OF THE INVENTION

Microprocessor-based monitoring devices circuit monitors, lighting control systems, meters, circuit breaker controllers, power monitors and the like use email messages to notify users of various changes that occur in the conditions being monitored. Such email notifications have limited value to their recipients because there is considerable amount of analysis and trouble-shooting that must be conducted to investigate the change and determine whether remedial action is required and, if so, the specific action to be taken. These problems are compounded when the message recipient is lacking a portion of the expertise required to effectively deal with the particular change reported in the email message.

### SUMMARY OF THE INVENTION

In one embodiment of the present invention, a system for monitoring an electrical power distribution system monitors a selected device or quantity in the power distribution system and produces an output signal representing a sensed condition; receives and stores data relating to the sensed condition from the power distribution system; stores a display of at least a portion of the stored data relating to the sensed condition; produces a message in response to a change in the output signal representing a change in the sensed condition and transmits the message to remote recipients, the message includes a hyperlink to the display so that a recipient of the message can use the hyperlink to effortlessly access the display to view data relating to the reported change in the sensed condition. In one specific embodiment, the message is an email message that is automatically transmitted to preselected remote recipients in response to the change in the sensed condition. Examples of sensed condition that can be reported by the message generated by the monitoring device are non-responsiveness of a circuit breaker, the length of the on time of a circuit breaker, or the loss of a communication line.

The email message is received by remote recipient devices which are linked to the display by a bidirectional data communication system, and which preferably contain web browsers to access the display via the Internet. The recipient devices may be personal computers, personal digital assistants, cellular telephones and the like which permit receipt of the message generated by the monitoring device, as well as use of the hyperlink, at any desired location.

The display that is accessed by the hyperlink may be one or more web pages displaying the stored data relating to the condition reported in the message. In another embodiment, the web server includes a home page, and the hyperlink is to that home page. The message may be transmitted by instant messaging rather than email.

### BRIEF DESCRIPTION OF THE DRAWINGS

The invention may best be understood by reference to the following description taken in conjunction with the accompanying drawings, in which:

FIG. 1 is a block representation of a power management system embodying the invention;

FIG. 2 is an exemplary display of a screen for setting up alarm messages to be generated by the system of FIG. 1;

FIG. 3 is an exemplary email alarm message generated by the system of FIG. 1 when configured as shown in FIG. 2;

FIG. 4 is an exemplary display of a web page accessed by a hyperlink in the email message of FIG. 3;

FIG. 5 is an exemplary email message generated by the system of FIG. 1 when configured as shown in FIG. 2, when the alarm condition has been remedied; and

FIG. 6 is an exemplary display of a web page accessed by a hyperlink in the email message of FIG. 5.

### DETAILED DESCRIPTION OF THE ILLUSTRATED EMBODIMENT

Although the invention will be described in connection with certain preferred embodiments, it will be understood that the invention is not limited to those particular embodiments. On the contrary, the invention is intended to include all alternatives, modifications and equivalent arrangements as may be included within the spirit and scope of the invention as defined by the appended claims.

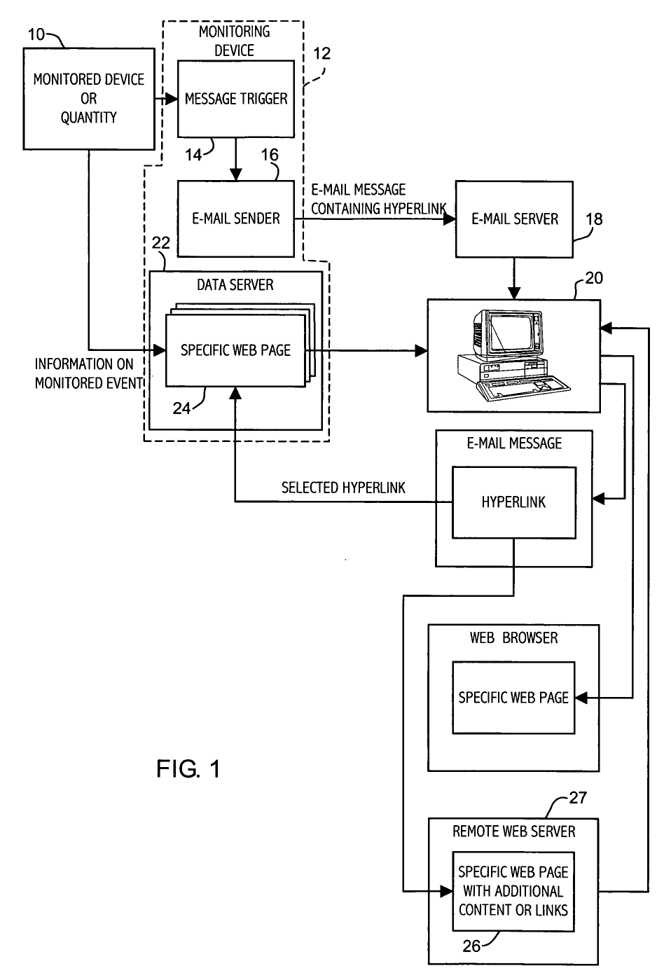

Referring now to the drawings, and initially to FIG. 1, a power distribution system includes a device or parameter 10 that is monitored by a monitoring device 12 coupled to the power distribution system. An example of a device that can be monitored is a circuit breaker, and an example of a parameter than can be monitored is the line current or voltage. The monitoring device 12 can be a controller programmed to detect one or more signals representing the monitored condition or conditions, and to analyze such signals or data derived from them. Examples of such monitoring devices are circuit monitors, meters, circuit breaker controllers, power monitors and the like.

Whenever the monitoring device 12 detects a predetermined condition, e.g., a non-responding circuit breaker, a message trigger 14 produces a signal that triggers an email sender 16 to generate an email message reporting the occurrence of that condition. The email message is automatically transmitted to pre-designated recipients identified by data stored in the monitoring device 12. The message is transmitted to one or more email servers 18, and then on to the identified recipients, who may receive the message on any device 20 having a web browser, such as a personal computer, a personal digital assistant (“PDA”), a cellular telephone or the like. The transmission medium is typically the Internet to permit the email messages to be quickly communicated to remote recipients, although other WAN's or bidirectional data communication systems may also be used. The recipient devices 20 can be connected to the Internet via any desired interface (wired or wireless) such as dial-in connections, cable modems or high-speed ISDN lines.

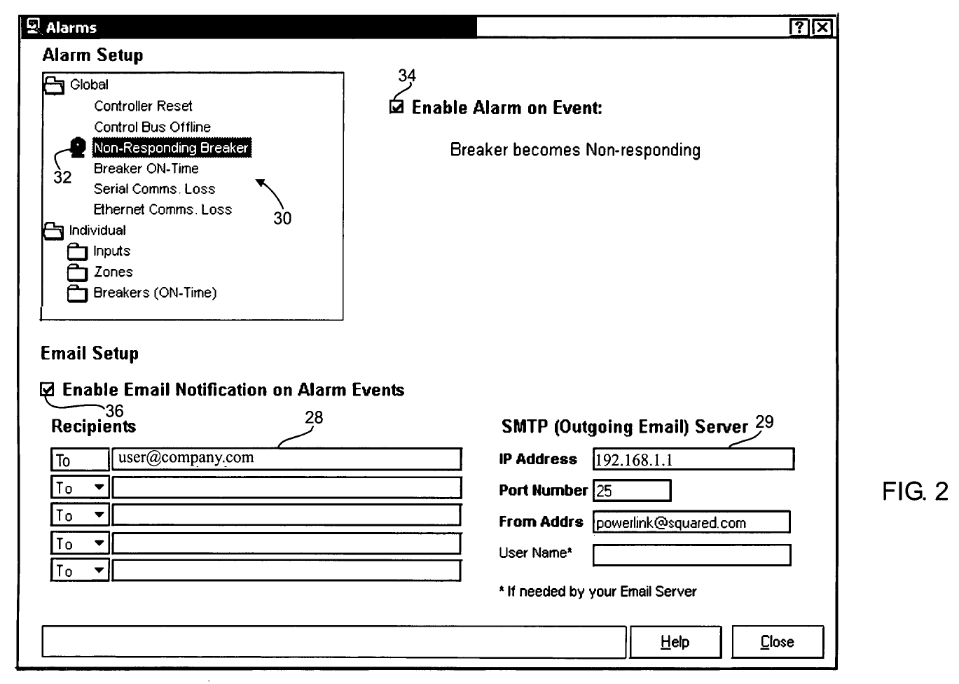

The monitoring device 12 is typically a controller that is integrated into a portion of an electrical power distribution system, such as a circuit breaker panel. For, example, the Square D NF3000G3 controller available from Schneider Electric SA plugs into a socket in a circuit breaker panel and includes a processor that can be programmed to perform a wide variety of different functions. For example, the controller can be programmed to generate alarm messages in response to the occurrence of any condition selected from a displayed list of alarm conditions. FIG. 2 is an example of such a list 30 displayed by the controller 12 and displaying six possible alarm conditions that can be selected by the user, namely, controller reset, control bus offline, non-responding breaker, breaker on-time, serial communication loss and ethernet communication loss. Breaker on-time, for example, can be used to monitor how many hours a load connected to a specified circuit breaker has been on, to determine whether that particular load should be serviced. In a lighting system, for example, it is often desirable to replace all the lamps in a particular circuit at the same time.

In the example depicted in FIG. 2, the condition selected to be monitored is the non-responsiveness of a circuit breaker. The icon 32 that appears beside “Non-Responsive Breaker” in the list 30 indicates that this is the condition selected to be monitored, so that an alarm will be generated when a monitored circuit breaker does not respond. The check mark in the box 34 indicates that an alarm is to be automatically generated when a monitored circuit breaker does not respond, and the check mark in the box 36 indicates that an email notification of any such alarm is to be automatically sent to the recipient designated by the email address 28 via the outgoing email server identified by the IP address 29.

With the alarm setup depicted in FIG. 2, the failure of a monitored circuit breaker to respond is detected by the monitoring device 12 that circuit breaker, and the message trigger 14 causes the email sender to transmit an email alarm message to the designated recipients via the Internet. The email message is transmitted to the email server identified by the address 29, for delivery to the remote recipient identified by the address 28.

The monitoring device 12 also includes a data server 22 that receives and stores data from the monitored device or quantity 10. The data server 22 is preferably an integral part of the monitoring device 12, but may be implemented in a separate controller if desired. A sub-part of the data server 22 is a web server that presents the stored data in multiple web pages 24 relating to the different alarm conditions, so that the different web pages can be accessed remotely via the Internet to view the data relating to the particular alarm condition identified in any email message. Each web page is specific to a particular alarm condition, and can be accessed directly by its IP address, or from the home page of the web server. The web server is connected to an internet service provider (ISP) by means of a typical Internet connection, e.g., cable modem, digital subscriber loop (DSL), etc.

The email message transmitted by the email sender 16 includes a hyperlink to the web server so that a recipient of the message can use the hyperlink to automatically access the web pages 24 or the web server that displays the web pages. This enables any recipient of the email message to quickly and easily access the appropriate web page 24, or the home page of the web server containing that web page, or a specific web page 26 on a different remote web server 27 for that alarm condition, by simply clicking on the hyperlink. The hyperlink passes to the recipient's web browser the URL for the file relating to the particular alarm condition identified in the email message containing the hyperlink. The URL, of course, includes the domain name of the web server, as well as the identification of the directory or folder that contains the web page relating to identified alarm condition. If desired, a password can be required as a part of this accessing process. Once the web server has been accessed, the email recipient can also request additional data.

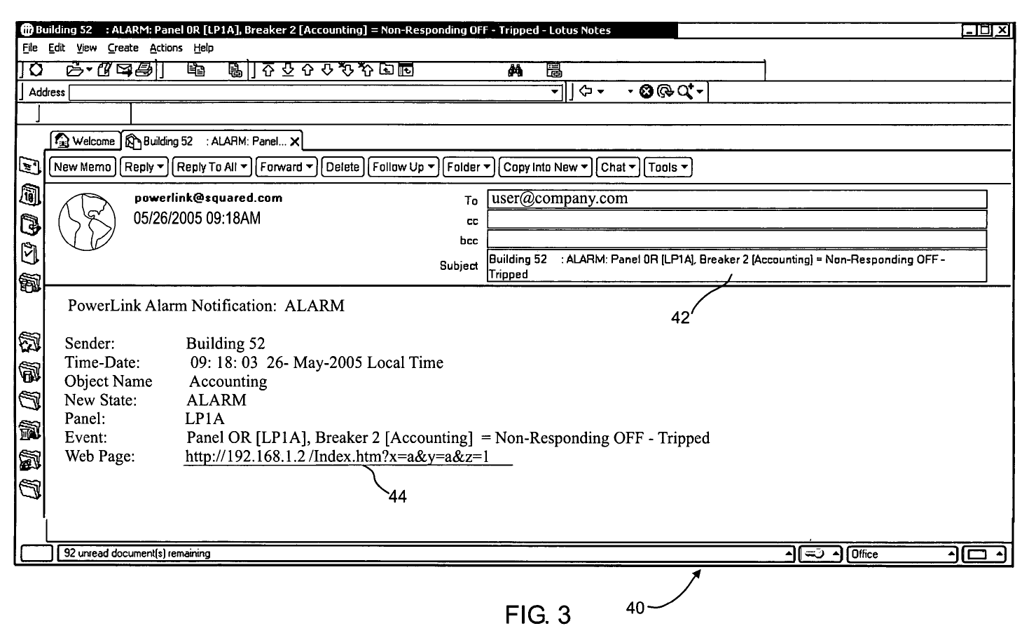

FIG. 3 is an example of an email message 40 generated by a controller 12 having the alarm setup depicted in FIG. 2, reporting a circuit breaker that has become non-responding. The subject line 42 of the message identifies the specific breaker that is non-responding, namely, Breaker 2 in Building 52's Panel LP1A which supplies power to the lights in the Accounting Department. It can be seen that the message 40 contains a hyperlink 44 to a specific web page 24 identified by a pointer in the hyperlink. This web page 24 is contained in the web server in the controller 12 and identified by the IP address in the hyperlink. Thus, the recipient of the email message 40 can simply click on the hyperlink 44 to cause the recipient's web browser to automatically access the specific web page that contains data relating to the condition that caused the alarm message, in this case a non-responding breaker.

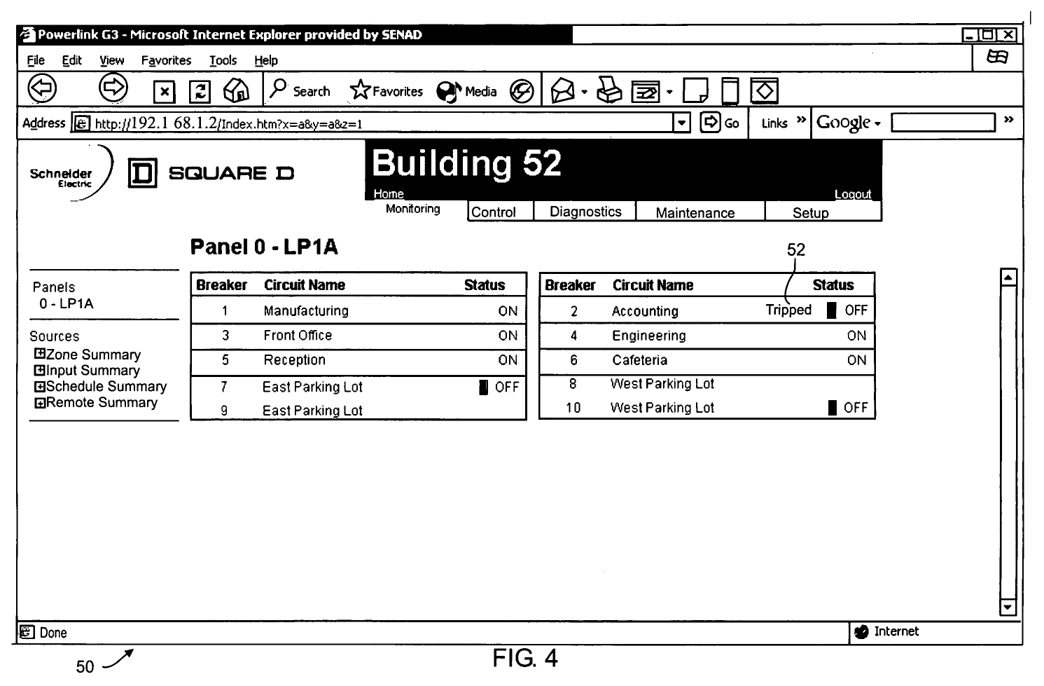

The web server transmits the accessed web page 24 to the recipient's device 20, as indicated at 28 in FIG. 2, thus enabling the recipient to immediately examine the data related to the condition that caused the alarm. An example of such a web page 50 is illustrated in FIG. 4, which shows the status of the panel containing the non-responding breaker. The information contained in this web page includes the panelboard name, the panelboard layout, circuit breaker numbers, circuit breaker names, and whether a circuit breaker is ON, OFF or tripped. The circuit breaker status is also indicated by color coded squares. In the example illustrated in FIG. 4, the non-responding breaker #2 is identified as “Tripped” and “Off” at 52. The recipient can determine what action should be taken on the basis of the information in the web page, or can proceed further by accessing additional data in the data server 22 via the web server, if needed. The appropriate remedial action may be effected via the Internet (when the breaker contacts are under the control of a micro-controller, they may be opened and closed remotely and regardless of whether an overload or fault condition exists), or manual assistance may be arranged.

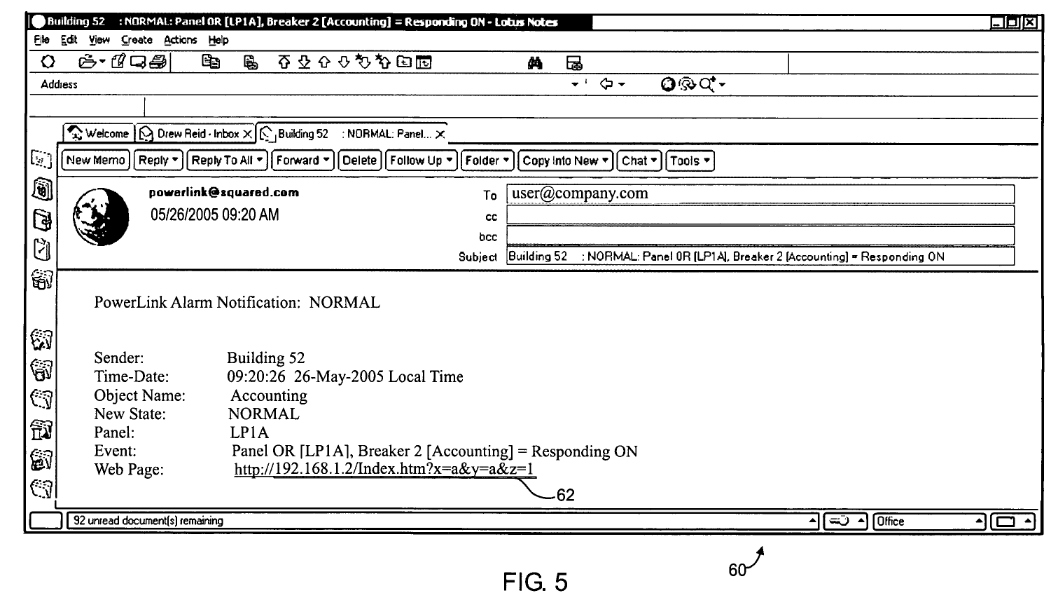

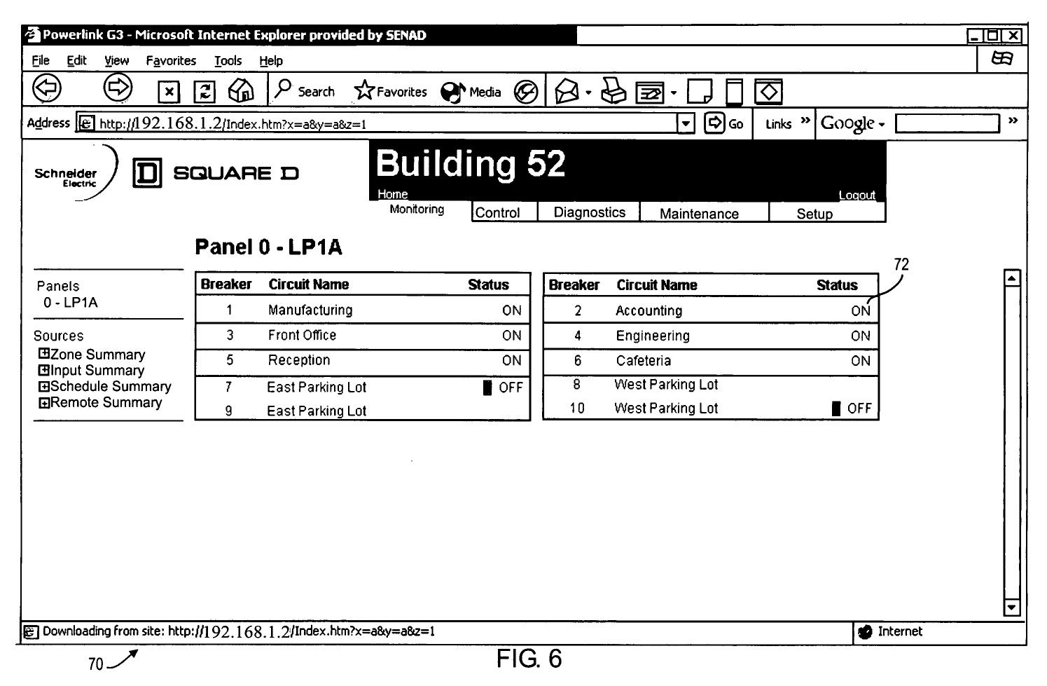

When the appropriate remedial action has been taken and the non-responding breaker is operating normally again, the monitoring device 12 detects this condition from the signal received from the monitored device or quantity 10. The message trigger 14 then generates and transmits a second email message notifying the designated recipient(s) that the alarm condition has been fixed. An example of such an email message 60 is shown in FIG. 5, which notifies the recipient that the circuit breaker in question has returned to normal operation. The message also contains a hyperlink 62 to a specific web page 24 containing the relevant information in the web server. The recipient again simply clicks on the hyperlink 62 to access the appropriate web page 24, which is transmitted to the recipient's device 20 by the web server, enabling the recipient to confirm that the alarm condition has been remedied and that the breaker is operating normally. An example of such a web page 70 is shown in FIG. 6, indicating that Breaker 2 for the Accounting Department is now “On.”

Although the examples shown in the drawings described above include hyperlinks to specific web pages 24, the hyperlink can be a simple link to the home page of the web server in the monitoring device 12, such as http://192.168.1.1. In this case, the recipient of the email message must search for the information pertaining to the condition reported in the email message. Software resident on the web server is responsive to user configuration and command information to display a variety of electrical status information. It is preferred that the hyperlink contain the additional coded information that enables the web server receiving the request from the recipient of the original email message to decipher the code and send back only the relevant information. This saves the recipient valuable time, since it provides the recipient direct access to the information pertaining to the condition reported in the email message. There is no need to be familiar with the web interface, nor to search for the relevant information. The hyperlink can include a query string type scheme to provide menu, sub-menu and page number or index information, such as:

http)://(IPaddr.)/Index.htm?x=[ParameterX]&y=[ParameterY]&z=[ParameterZ].
Parameter X can represent what type of information to display, such as a status page providing detailed data not contained in the email or a control page to take action and fix the condition reported by the email.
Parameter Y can represent the device, object or location that contains this type of data.
Parameter Z can represent an index should the object or device be part of a group or array of devices or objects.

Thus, the hyperlink can be prepared by an expert to provide the message recipients with the specific information required to deal with the particular event identified in the email notification, which can be of great value to a recipient who is less experienced than the expert who designed the web page containing the information required to deal with the condition reported in the email message. The information contained in the web page can be preselected to help the viewer quickly identify the cause of the condition, and can even suggest the remedial actions that can be taken to correct the condition. Thus, each message recipient obtains the benefit of the expert's knowledge, regardless of where the recipient and the expert are located when the message is received. If desired, the web page or additional hyperlinks contained on the web page may include pre-recorded multimedia instructions or information relating to the reported condition and how to correct it. Even video instructions can be streamed or downloaded as part of the web page, providing full-screen, full-motion video assistance. The video data that is transmitted may be tailored to factors such as screen resolution and available bandwidth. Video, audio, database, spreadsheet, text and graphical information may be provided in any desired combination.

While the particular embodiment described above used a single monitoring device, it will be understood that multiple monitoring devices may supply signals or data to one or more controllers that process the received information and generate specific email notifications containing hyperlinks that are customized for each condition that triggers such a notification. Similarly, the data server may store data other than that which is directly related to the events that cause messages to be produced, and in this case the messages may contain additional hyperlinks to data that is not directly related to the event reported in the respective messages. Alternatively, such additional hyperlinks may be contained in the web server so that they become available when a message recipient accesses the web server. The messages generated in the monitoring device in the embodiment described above may be transmitted by instant messaging instead of email.

While particular embodiments and applications of the present invention have been illustrated and described, it is to be understood that the invention is not limited to the precise construction and compositions disclosed herein and that various modifications, changes, and variations may be apparent from the foregoing descriptions without departing from the spirit and scope of the invention as defined in the appended claims.

What is claimed is:

1. A monitoring system for an electrical power distribution system, comprising
at least one monitoring device coupled to said power distribution system and producing an output signal representing a sensed condition,
a data server receiving and storing data relating to said sensed condition from the power distribution system, said data server including a web server for transmitting a display of at least a portion of said stored data relating to said sensed condition,
a controller receiving said output signal and producing a message in response to a change in said output signal representing a change in said sensed condition, said message including a hyperlink to said web server so that a recipient of said message can use said hyperlink to automatically access said web server to view data relating to said reported change in said sensed condition, and
a message transmission device for transmitting said message to remote recipients.

2. The monitoring system of claim 1 wherein said data server is an integral part of said controller.

3. The monitoring system of claim 1 wherein said message is an email message, and said system includes an email sender that automatically transmits said email message to preselected remote recipients.

4. The monitoring system of claim 1 wherein said web server includes at least one web page displaying said stored data, and said hyperlink is to said web page.

5. The monitoring system of claim 1 wherein said web server includes a home page, and said hyperlink is to said home page.

6. The monitoring system of claim 1 which includes a circuit breaker panel, and said controller is a part of said circuit breaker panel.

7. The monitoring system of claim 1 wherein said controller transmits said message by instant messaging.

8. The monitoring system of claim 1 wherein said controller is configurable such that preselected conditions can be used to produce said message.

9. The monitoring system of claim 1 which includes remote recipient devices containing web browsers to receive said message and to access said web server, said recipient devices being linked to said data server by a bidirectional data communication system.

10. The monitoring system of claim 9 wherein said recipient devices include at least one device selected from the group consisting of personal computers, personal digital assistants, and cellular telephones.

11. The monitoring system of claim 9 wherein said bidirectional data communication system is a wired or wireless network.

12. The monitoring system of claim 1 in which said data server stores data not related to said sensed condition, and said message includes at least a second hyperlink to said data not related to said sensed condition.

13. The monitoring system of claim 1 wherein at least one of said message and said web server includes at least a second hyperlink to data stored external to said data server.

14. The monitoring system of claim 1 wherein said sensed condition is at least one condition selected from the group consisting of non-responsiveness of a controllable circuit breaker, the length of the on time of a circuit breaker, and the loss of a communication line.

15. A method of monitoring an electrical power distribution system, comprising
monitoring a selected device or quantity in said power distribution system and producing an output signal representing a sensed condition,
receiving and storing data relating to said sensed condition from the power distribution system,
storing a display of at least a portion of said stored data relating to said sensed condition,
producing a message in response to a change in said output signal representing a change in said sensed condition, said message including a hyperlink to said display so that a recipient of said message can use said hyperlink to automatically access said display to view data relating to said reported change in said sensed condition, and
transmitting said message to remote recipients.

16. The monitoring method of claim 15 wherein said message is an email message that is automatically transmitted to preselected remote recipients in response to said change in said sensed condition.

17. The monitoring method of claim 15 wherein said display is at least one web page displaying said stored data, and said hyperlink is to said web page.

18. The monitoring method of claim 15 wherein said message is transmitted by instant messaging.

19. The monitoring method of claim 15 wherein said email message is received by remote recipient devices containing web browsers to access said display, said recipient devices being linked to said display by a bidirectional data communication system.

20. The monitoring method of claim 19 wherein said recipient devices include at least one device selected from the group consisting of personal computers, personal digital assistants, and cellular telephones.

21. The monitoring method of claim 15 which includes storing data not related to said sensed condition, and said message includes at least a second hyperlink to said data not related to said sensed condition.

22. The monitoring method of claim 15 wherein said sensed condition is at least one condition selected from the group consisting of non-responsiveness of a controllable circuit breaker, the length of the on time of a circuit breaker, and the loss of a communication line.
